(19) United States
(12) Patent Application Publication
(10) Pub. No.: US 2015/0250244 A1
(43) Pub. Date: Sep. 10, 2015

(54) Reflective Headwear

(71) Applicant: Todd George Jackson, Tampa, FL (US)

(72) Inventor: Todd George Jackson, Tampa, FL (US)

(21) Appl. No.: 14/202,157

(22) Filed: Mar. 10, 2014

(51) Int. Cl. A42B 1/24; F21K 2/00

(52) U.S. Cl. CPC A42B 1/242; F21K 2/00

(57) ABSTRACT

The reflective headwear combines a reflective insulation material made with two layers of 96% reflective metalized aluminum separated by 5/16″ enclosed airspace, a piece of fabric, stitching, and adhesives to create various styles of sun reflecting and heat absorbing headwear for everyday use outside.

### REFERENCE TO PROVISIONAL PATENT

This Nonprovisional Utility Patent is filed within one (1) year of the filing of the Provisional Patent Application No. 61/851632 filed on Mar. 12, 2013 by Todd Jackson.

### FIELD OF THE INVENTION

The invention pertains to the field of apparel. More particularly, the invention pertains to headwear. Specifically, the invention pertains to sun-protecting headwear.

### SUMMARY OF THE INVENTION

The purpose of the invention is to provide a reflective material to deflect sun and heat rays. This enhances sun protection and creates a cooler environment for individuals when outdoors. The reflective headwear can be used to extend the bill of a cap or visor for broader protection of face, ears, and neck; worn attached by a strap or to glasses; or as a visor or a full hat.

### BRIEF DESCRIPTION OF THE DRAWING

FIG. 1 shows the reflective headwear alone, unattached to any headwear with adhesives on the bottom, fabric side, and the top side made of a reflective insulation material. It also depicts the dimensions of the reflective headwear.

To assemble, connect the adhesive side of the reflective headwear to the adhesive side of a cap or other preferred headwear and apply light pressure.

FIG. 2 depicts the left profile view of the reflective headwear for attachment to other headwear.

FIG. 3 shows the reflective headwear with a sweat absorbent brim with slits designed for wear eyewear. It also depicts the dimensions of the reflective headwear for use with eyewear.

To assemble, insert the temples of a piece of eyewear through the material underside of the reflective headwear and slide the reflective headwear to desired location on the eyewear.

FIG. 4 depicts the left profile view of the reflective headwear modified for eyewear.

FIG. 5 shows the reflective headwear modified to stand alone as its own visor, with a hook and loop fastener strap, other adhesive strap, or a buckled strap to attach around the head. It also depicts the dimensions of the free standing reflective headwear visor.

FIG. 6 depicts the left profile view of the stand-alone reflective headwear visor.

FIG. 7 shows the reflective headwear as a complete brimmed hat and its relative dimensions.

FIG. 8 depicts that left profile view of the reflective headwear as a complete brimmed hat.

### DETAILED DESCRIPTION OF THE INVENTION

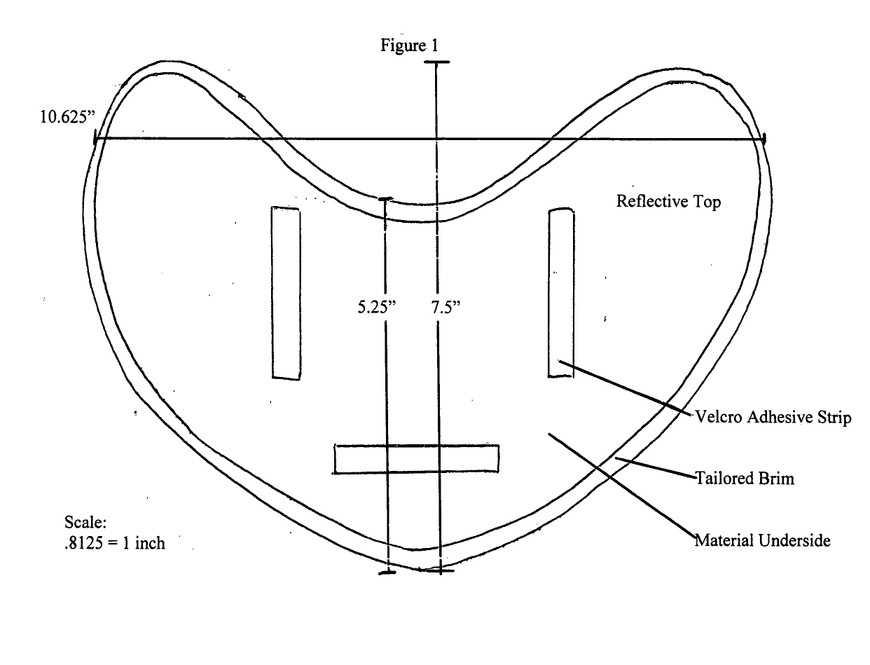

As shown in FIG. 1, the reflective headwear is made of a reflective insulation material with the reflective insulation material exposed on the top side and apparel fabric stitched to the bottom side or in other decorative ways. The reflective insulation material is an insulation material typically used in houses to insulate various parts of a house and is made with two layers of 96% reflective metalized aluminum separated by 5/16″ enclosed airspace. As shown in FIG. 1, adhesives are placed on the fabric side of the reflective headwear so that the reflective insulation material faces upward. Adhesives are also placed on the bill of a billed cap or another piece of headwear. To assemble the reflective headwear to a cap or other head gear, the reflective headwear is placed, adhesive and fabric side down, on top of the bill of a cap or preferred piece of headwear and pressure applied to ensure that the reflective headwear and the preferred headwear are connected. The reflective headwear that attaches to headwear is cut to be 7½″ long, 10⅝″ wide, and 5/16″ thick; however, the actual finished product dimensions are minimally reduced after assembly and may vary slightly based upon stitching. The reflective headwear shown in FIG. 1 is made by using reflective headwear shown in FIG. 1 is made by using reflective insulation material, any type of fabric, and any type of headwear. The reflective headwear shown in FIG. 1 provides additional shade from the sun by extending the bill of a cap or other headwear while also reflecting and absorbing the sun and heat rays.

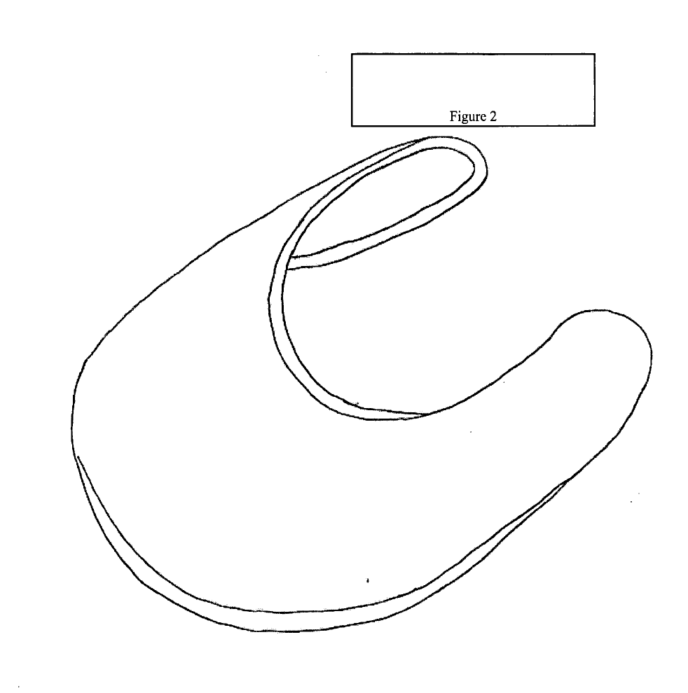

FIG. 2 provides a sketch of the left side profile of the reflective headwear that depicts a more realistic image of the reflective headwear to be attached to preferred headwear showcasing the curvature of the reflective headwear.

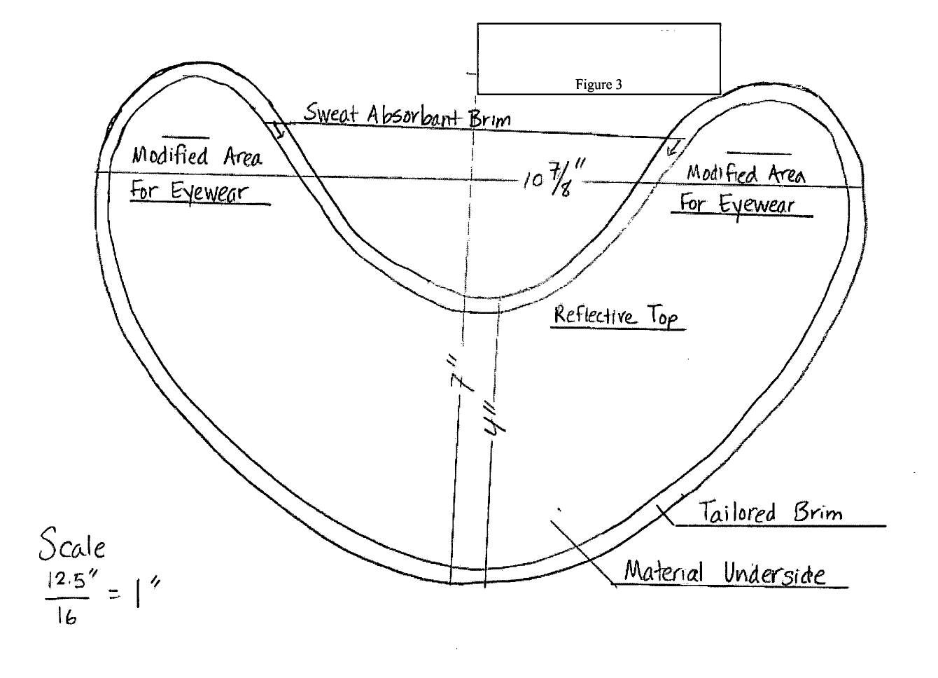

As shown in FIG. 3, the reflective headwear is made of a reflective insulation material with the reflective insulation material exposed on the top side and apparel fabric stitched to the bottom side or in other decorative ways. The reflective insulation material is an insulation material typically used in houses to insulate various parts of a house and is made with two lawyers of 96% reflective metalized aluminum separated by 5/16″ enclosed airspace. As shown in FIG. 3, no adhesives are placed on the fabric side of the reflective headwear; rather, two slits are made towards the back of the visor to accommodate the insertion of eyewear. To assemble the reflective headwear to eyewear, place the temples of eyewear into the fabric side of the reflective headwear so that the ends of the eyewear come out on top of the reflective side. The reflective headwear is then adjusted on the temples of the eyewear to the desired location. The reflective headwear that attaches to eyewear is cut to be 7″ long, 10⅝″ wide, and 5/16″ thick however, the actual finished product dimensions are minimally reduced after assembly and may vary slightly based upon stitching. The reflective headwear shown in FIG. 3 is made by using reflective insulation material, any type of fabric, and any pair of eyewear. In addition, the eyewear reflective headwear has a sweat absorbent brim to catch sweat that may form on the forehead or other part of the face. The reflective headwear shown in FIG. 3 provides additional shade from the sun by attaching a bill, with a sweat absorbent brim, to any pair of eyewear, while also reflecting and absorbing the sun and heat rays.

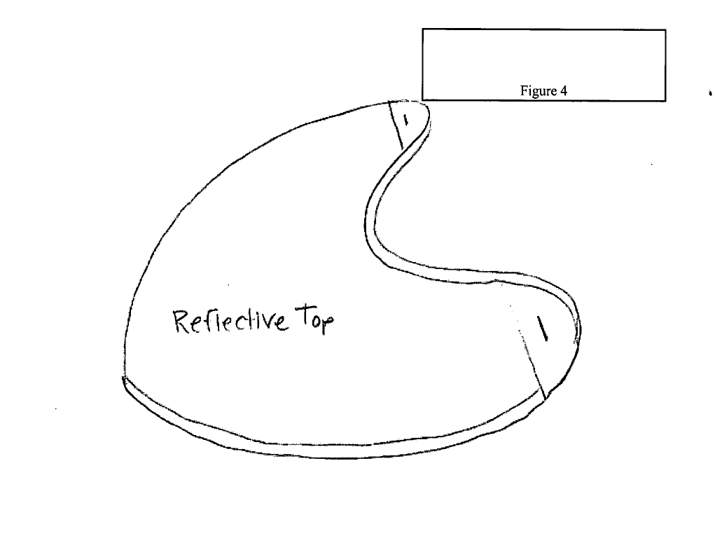

FIG. 4 provides a sketch of the left side profile of the reflective headwear that depicts a more realistic image of the eyewear reflective headwear showcasing the curvature of the reflective headwear.

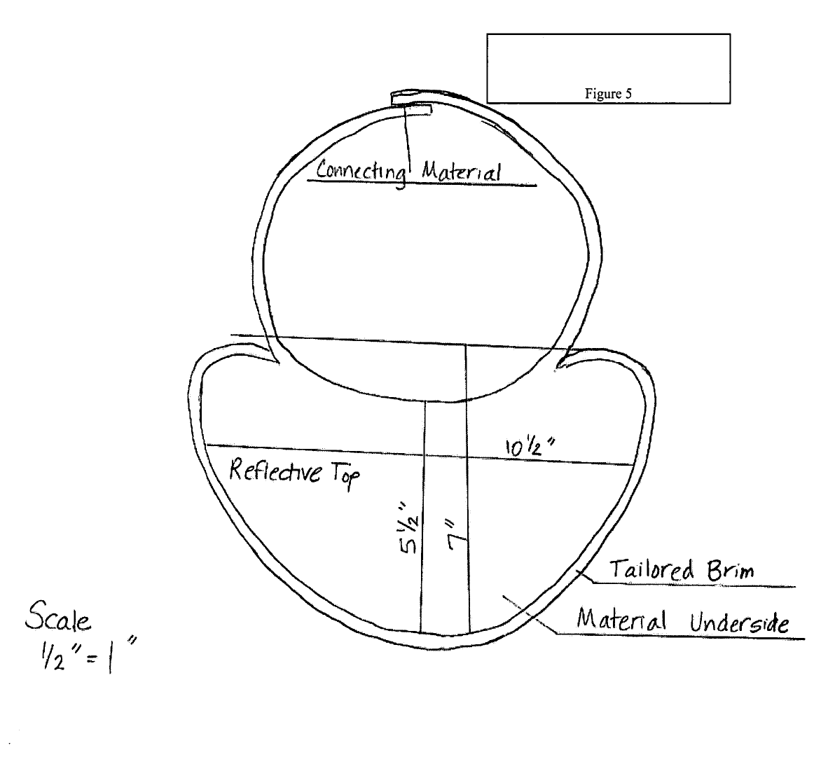

As shown in FIG. 5, the reflective headwear is made of a reflective insulation material with the reflective insulation material exposed on the top side and apparel fabric stitched to the bottom side or in other decorative ways. The reflective insulation material is an insulation material typically used in houses to insulate various parts of a house and is made with two layers of 96% reflective metalized aluminum separated by 5/16″ enclosed airspace. As shown in FIG. 5, a thin piece of reflective insulation material is attached to the visor and extends around the head on each side of the visor. The two thin pieces of reflective insulation material connect by the use of a hook and loop fastener, other adhesive, or a buckle in the back. Essentially FIG. 5's design creates a free standing visor without the need for head gear or eyewear. To assemble the freestanding reflective headwear, place the visor around the head and attach the hook and loop fastener or other adhesive in the back. The free standing reflective headwear is cut to be 7″ long plus the diameter for the head area, 10½″ wide and 5/16″ thick; however, the actual finished product dimensions are minimally reduced after assembly and may vary slightly based upon stitching. The reflective headwear shown in FIG. 5 is made by using reflective insulation material and any type of fabric. In addition, the freestanding reflective headwear has a sweat absorbent brim to catch sweat that may form on the forehead or other part of the face. The reflective headwear shown in FIG. 5 provides shade from the sun by providing a freestanding visor that extends over the face, while also reflecting and absorbing the sun and heat rays.

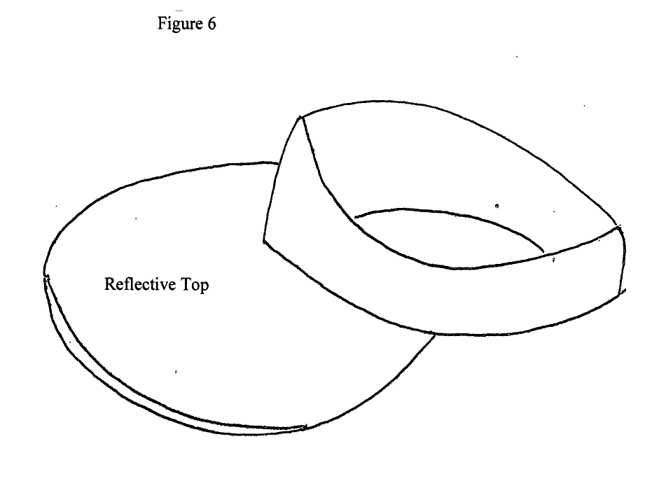

FIG. 6 provides a sketch of the left side profile of the reflective headwear that depicts a more realistic image of the freestanding reflective headwear showcasing the curvature of the reflective headwear.

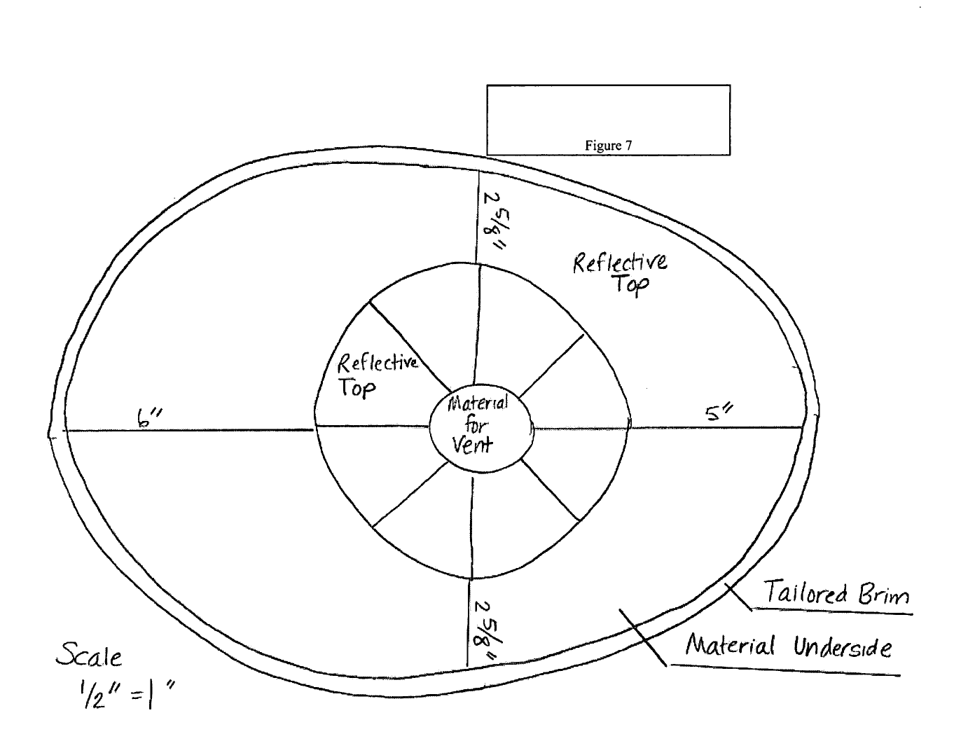

As shown in FIG. 7, the reflective headwear is made of a reflective insulation material with the reflective insulation material exposed on the top side and apparel fabric stitched to the bottom side or in other decorative ways. The reflective insulation material is an insulation material typically used in houses to insulate various parts of a house and is made with two layers of 96% reflective metalized aluminum separated by 5/16″ enclosed airspace. As shown in FIG. 7, the reflective insulation material extends around the entire head to create a large brimmed hat providing protection to the face and the neck. The reflective hat is 5/16″ thick, and its length and width depend upon the head area. The reflective hat is cut and designed for a head area range from 6″ to 9″ in diameter, with a 6″ bill extending in the front, a 5″ bill extending in the back and 2⅝″ bills extending on either side of the head; however, the actual finished product dimensions are minimally reduced after assembly and may vary slightly based upon stitching. The reflective hat is equipped with a vent at the top of the hat to allow air to flow. The reflective headwear shown in FIG. 7 assumes a 7″ head area diameter and is made by using reflective insulation material and any type of fabric. The reflective hat shown in FIG. 7 provides shade from the sun by extending over the face, neck and ear and also reflecting and absorbing the sun and heat rays.

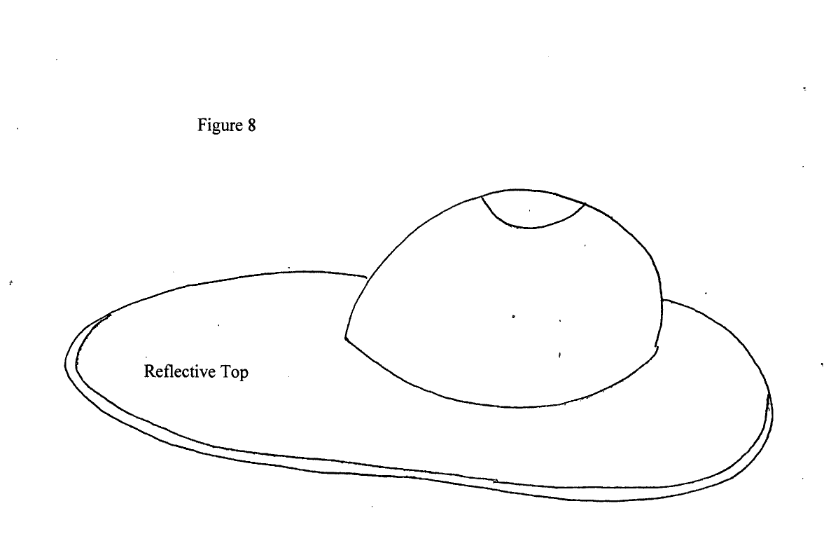

FIG. 8 provides a sketch of the left side profile of the reflective hat that depicts a more realistic image of the reflective hat showcasing the curvature of the reflective headwear.

Accordingly, it is to be understood that the embodiments of the invention herein described are merely illustrative of the application of the principles of the invention. Reference herein to the details of the illustrated embodiments is not intended to limit the scope of the claims, which themselves recite those features regarded as essential to the invention.

1. A reflective headwear comprising: reflective insulation material made with two layers of 96% reflective metalized aluminum separated by 5/16″ enclosed airspace and a piece of fabric, wherein the reflective insulation material and the fabric are each cut into corresponding shapes stitched together so that the fabric and reflective insulation material become one piece of material;
the dimensions of the final reflective headwear are minimally reduced upon assembly.

2. The reflective headwear of claim 1 cut into a “u” shape with dimensions of 7½″ long, 10⅝″ wide further comprising: an adhesive material and a billed cap or other piece of headwear wherein the adhesive material is applied to the fabric side of the reflective headwear and the adhesive material is also applied to the top side of the bill of the billed cap or other piece of headwear and the adhesives on the reflective headwear and the billed cap or other piece of headwear are put together so that they are touching.

3. The reflective headwear of claim 1 cut into a “u” shape with dimensions of 7″ long, 10⅝″ wide further comprised of two slits towards the back of the reflective headwear and a pair of eyewear wherein the temples of the eyewear are placed into the fabric side of the reflective headwear so that the ends of the eyewear come out on top of the reflective side.

4. The reflective headwear of claim 1 cut into a “u” shape with dimensions of 7″ long, 10⅝″ wide further comprised of an additional thin piece of reflective insulation material and an adhesive material wherein the additional thin piece is stitched to the “u” so that the thin piece of reflective insulation material will extend around a person's head to form a free standing visor and the adhesive material is applied to top side of the left end of the free standing visor and to the bottom side of the right end of the free standing visor and are put together so that they are touching.

5. The reflective headwear of claim 1 with a 9″ diameter circle cut in the center and a bill extending 6″ in the front from the center circle, 5″ in the back from center circle and 2⅝″ on either side of the center circle further comprised of a reflective insulation material dome with a small circular hole in the top of the dome and mesh like material wherein the large oval created by the cuts is stitched to the reflective insulation material dome; the mesh like material is cut into a small circular hole measuring 1/16″ larger in diameter than the hole in the top of the dome and the mesh like material is stitched to the inside of the dome's small circle.
